(19) United States
(12) Patent Application Publication
(10) Pub. No.: US 2025/0277536 A1
(43) Pub. Date: Sep. 4, 2025

(54) WATER RELEASE APPARATUS

(71) Applicant: EverTek Industries Inc., Taichung City (TW)

(72) Inventors: LIANG-TING WU, Taichung City (TW); MIEN-HSING CHANG, Taichung City (TW)

(21) Appl. No.: 18/590,970

(22) Filed: Feb. 29, 2024

(51) Int. Cl. F16K 11/00; E03C 1/02; E03C 1/04

(52) U.S. Cl. CPC F16K 19/006; E03C 1/0403; E03C 2001/026

(57) ABSTRACT

A water release apparatus includes a container having a cold-water valve mounting hole, a hot-water valve mounting hole, and a water release valve mounting hole; and a valve assembly including a cold-water valve, a hot-water valve, a water release valve respectively including a cold-water valve body, a hot-water valve body, and a water release valve body respectively seated in the cold-water valve mounting hole, the hot-water valve mounting hole, and the water release valve mounting hole and connected by a connection pipe. A cold-water valve bottom supporting member and a cold-water valve top supporting ring are mounted to the cold-water valve body. A hot-water valve bottom supporting member and a hot-water valve top supporting ring are mounted to the cold-water valve body. A water release valve bottom supporting member and a water release valve top supporting ring are mounted to a water release valve body.

### BACKGROUND OF THE INVENTION

### Technical Field of the Invention

The present invention relates to a water release apparatus, and more particularly to a water release apparatus that enables easy installation and part replacement.

### Description of the Prior Art

Water release apparatuses, particularly water release apparatuses installed in residence houses, generally comprise a container (such as a wash basin, a bath tub, a kitchen sink, and the likes) and a valve assembly mounted on the container. However, actually, due to the difficulty of the operation of mounting the valve assembly and the container, it is common to separately purchase the valve assembly and the container and then having a plumber to install and set up the valve assembly and the container at home. This results in necessity of spending extra money to have plumbers to do the installation, in addition to the cost of purchases.

Further, the valve assembly, as being purchased, includes a valve contained therein and external decorations that are already set in a combined condition, making it hard to disassemble. Consequently, after a period of time of use by ordinary people, if one of the decorations is broken, it needs to replace the entire set of the valve assembly, and it is not possible to simply replace the broken part. This is a concern of money squandering.

### SUMMARY OF THE INVENTION

Thus, in order to overcome the problems of the prior art water release apparatus that assembling is difficult and replacement of parts is not easy, the present invention provides a water release apparatus, which comprises: a container, which comprises a water outflow basin that is recessed and extended from a top side to a bottom side and a surface panel arranged at one side of the water outflow basin, the surface panel comprising a cold-water valve mounting hole, a hot-water valve mounting hole, and a water release valve mounting hole; and a valve assembly, which comprises a cold-water valve, a hot-water valve, a water release valve, and a connection pipe, the cold-water valve comprising a cold-water valve body, a cold-water valve bottom supporting member, and a cold-water valve top supporting ring, the cold-water valve body comprising an outside circumferential surface that comprises a cold-water valve lower thread and a cold-water valve upper thread, the cold-water valve bottom supporting member comprising a nut, the cold-water valve top supporting ring comprising a nut, the hot-water valve comprising a hot-water valve body, a hot-water valve bottom supporting member, and a hot-water valve top supporting ring, the hot-water valve body comprising an outside circumferential surface that comprises a hot-water valve lower thread and a hot-water valve upper thread, the hot-water valve bottom supporting member comprising a nut, the hot-water valve top supporting ring comprising a nut, the water release valve being arranged between the cold-water valve and the hot-water valve, the water release valve comprising a water release valve body, a water release valve bottom supporting member, and a water release valve top supporting ring, the water release valve body comprising an outside circumferential surface that comprises a water release valve thread, the water release valve bottom supporting member comprising a nut, the water release valve top supporting ring comprising a nut, the connection pipe connecting the cold-water valve body, the hot-water valve body, and the water release valve body, wherein the cold-water valve bottom supporting member is screwed to the cold-water valve lower thread, and the hot-water valve bottom supporting member is screwed to the cold-water valve lower thread, and the water release valve bottom supporting member is screwed to the water release valve thread, and the cold-water valve body, the hot-water valve body, and the water release valve body are respectively inserted, from the bottom side to the top side, into the cold-water valve mounting hole, the hot-water valve mounting hole, and the water release valve mounting hole of the container, such that the cold-water valve bottom supporting member, the hot-water valve bottom supporting member, and the water release valve bottom supporting member are positioned against an undersurface of the surface panel, and then, the cold-water valve top supporting ring is screwed to the cold-water valve upper thread, and the hot-water valve top supporting ring is screwed to the hot-water valve upper thread, and the water release valve top supporting ring is screwed to the water release valve thread, such that the cold-water valve top supporting ring, the hot-water valve top supporting ring, and the water release valve top supporting ring are located on and positioned against a top surface of the surface panel, while the connection pipe is located on an underside of the surface panel. In this way, an effect that a user is allowed to do assembling easily and replacement of parts can be achieved easily.

### BRIEF DESCRIPTION OF THE DRAWINGS

FIG. 1 is an exploded view showing a first preferred embodiment of the present invention.

FIG. 2 is a perspective view showing the embodiment of FIG. 1 in an assembled form.

FIG. 3 is a cross-sectional view showing the embodiment of FIG. 1 in an assembled form.

FIG. 4 is a schematic view showing installation of the embodiment of FIG. 1.

FIG. 5 is an exploded view showing a second preferred embodiment of the present invention.

FIG. 6 is a perspective view showing the embodiment of FIG. 5 in an assembled form.

FIG. 7 is a cross-sectional view showing the embodiment of FIG. 5 in an assembled form.

FIG. 8 is an exploded view showing a third preferred embodiment of the present invention.

FIG. 9 is a perspective view showing the embodiment of FIG. 8 in an assembled form.

FIG. 10 is a cross-sectional view showing the embodiment of FIG. 8 in an assembled form.

FIG. 11 is a cross-sectional view of the embodiment shown in FIG. 8 in an assembled form.

### DETAILED DESCRIPTION OF THE PREFERRED EMBODIMENTS

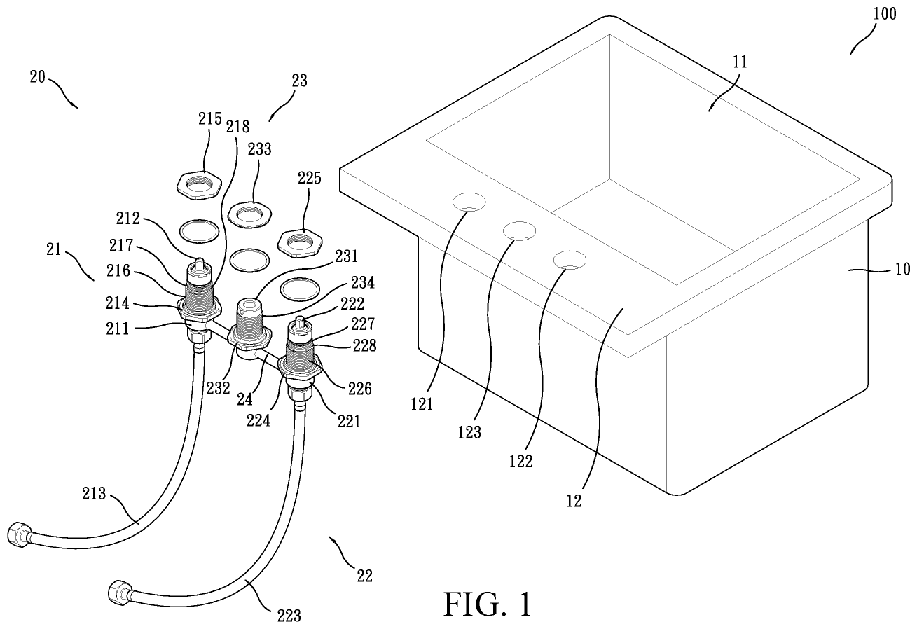

Referring to FIGS. 1-4, a water release apparatus 100 according to a first preferred embodiment of the present invention mainly comprises a container 10 and a valve assembly 20.

Referring to FIG. 1, the container 10 comprises a water outflow basin 11 that is recessed and extended from a top side to a bottom side and a surface panel 12 arranged at one side of a top of the water outflow basin 11. The surface panel 12 comprises a cold-water valve mounting hole 121, a hot-water valve mounting hole 122, and a water release valve mounting hole 123.

Referring to FIGS. 1-3, the valve assembly 20 comprises a cold-water valve 21, a hot-water valve 22, a water release valve 23, and a connection pipe 24. The cold-water valve 21 comprises a cold-water valve body 211, a cold-water valve core 212 arranged in an interior of the cold-water valve body 211, a cold-water pipe 213 connected to a bottom end of the cold-water valve body 211, a cold-water valve bottom supporting member 214, and a cold-water valve top supporting ring 215. The cold-water valve body 211 has an outside circumferential surface that comprises a cold-water valve lower thread 216 and a cold-water valve upper thread 217. An outside diameter of the cold-water valve upper thread 217 is smaller than an outside diameter of the cold-water valve lower thread 216, such that a cold-water valve stepped face 218 is formed on the outside surface of the cold-water valve body 211 between the cold-water valve lower thread 216 and the cold-water valve upper thread 217. The cold-water valve bottom supporting member 214 is a nut, and the cold-water valve top supporting ring 215 is a nut. The hot-water valve 22 comprises a hot-water valve body 221, a hot-water valve core 222 arranged in an interior of the hot-water valve body 221, a hot-water pipe 223 connected to a bottom end of the hot-water valve body 221, a hot-water valve bottom supporting member 224, and a hot-water valve top supporting ring 225. The hot-water valve body 221 has outside circumferential surface that comprises a hot-water valve lower thread 226 and a hot-water valve upper thread 227. An outside diameter of the hot-water valve upper thread 227 is smaller than an outside diameter of the hot-water valve lower thread 226, such that a hot-water valve stepped face 228 is formed on the outside surface of the hot-water valve body 221 between the hot-water valve lower thread 226 and the hot-water valve upper thread 227. The hot-water valve bottom supporting member 224 is a nut, and the hot-water valve top supporting ring 225 is a nut. The water release valve 23 is arranged between the cold-water valve 21 and the hot-water valve 22, and the water release valve 23 comprises a water release valve body 231, a water release valve bottom supporting member 232, and a water release valve top supporting ring 233. The water release valve body 231 has an outside circumferential surface that comprises a water release valve thread 234. The water release valve bottom supporting member 232 is a nut, and the water release valve top supporting ring 233 is a nut. The connection pipe 24 connects the cold-water valve body 211 of the cold-water valve 21, the hot-water valve body 221 of the hot-water valve 22, and the water release valve body 231 of the water release valve 23.

Thus, the above provides a description of various components of the water release apparatus 100 according to one preferred embodiment of the present invention, and in the following, assembly and features thereof will be described as follows.

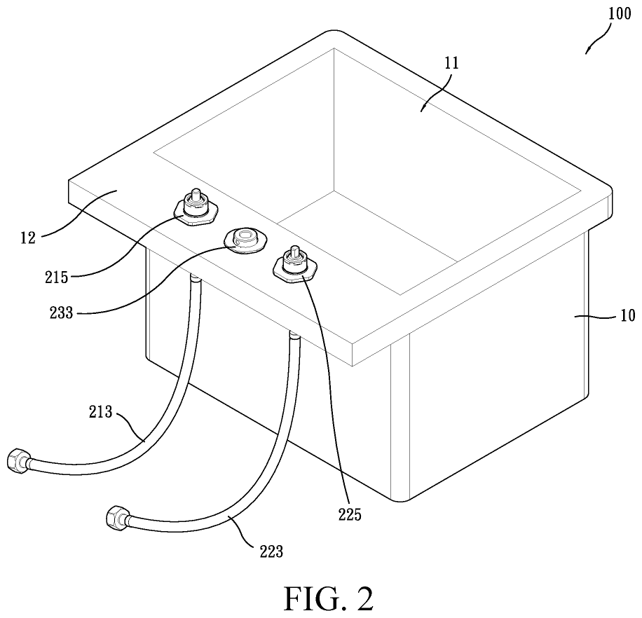

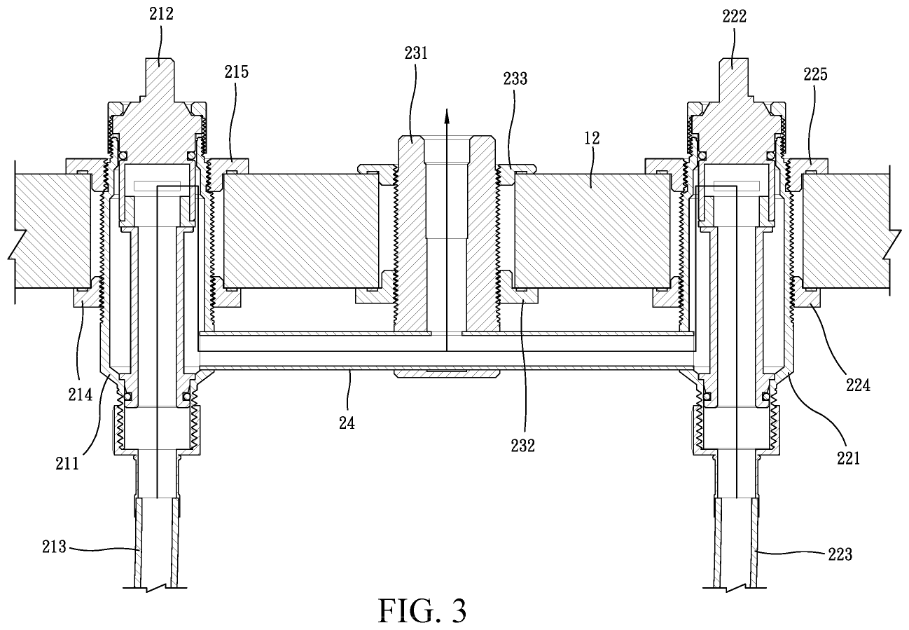

To assemble the present invention, the cold-water valve bottom supporting member 214 is first screwed to the cold-water valve lower thread 216, and the hot-water valve bottom supporting member 224 is screwed to the hot-water valve lower thread 226, and the water release valve bottom supporting member 232 is screwed to the water release valve thread 234. Then, the cold-water valve body 211, the hot-water valve body 221, and the water release valve body 231 are inserted, from the bottom side toward the top side, into the cold-water valve mounting hole 121, the hot-water valve mounting hole 122, and the water release valve mounting hole 123 of the container 10, respectively (as shown in FIGS. 2 and 3), such that the cold-water valve bottom supporting member 214, the hot-water valve bottom supporting member 224, and the water release valve bottom supporting member 232 are positioned against an undersurface of the surface panel 12 of the container 10 (as shown in FIG. 3). And, then, the cold-water valve top supporting ring 215 is screwed to the cold-water valve upper thread 217, and the hot-water valve top supporting ring 225 is screwed to the hot-water valve upper thread 227, and the water release valve top supporting ring 233 is screwed to the water release valve thread 234, such that the cold-water valve top supporting ring 215, the hot-water valve top supporting ring 225, and the water release valve top supporting ring 233 are located on and positioned against a top surface of the surface panel 12 of the container 10, while the connection pipe 24 is located on the underside of the surface panel 12 (as shown in FIG. 3).

As such, the operation of assembling present invention can be carried out in advance in a workshop to be then shipped to a sales shop for exhibition or directly delivered to a purchaser's residence to thereby reduce the difficulty for the user to do installation by himself or herself.

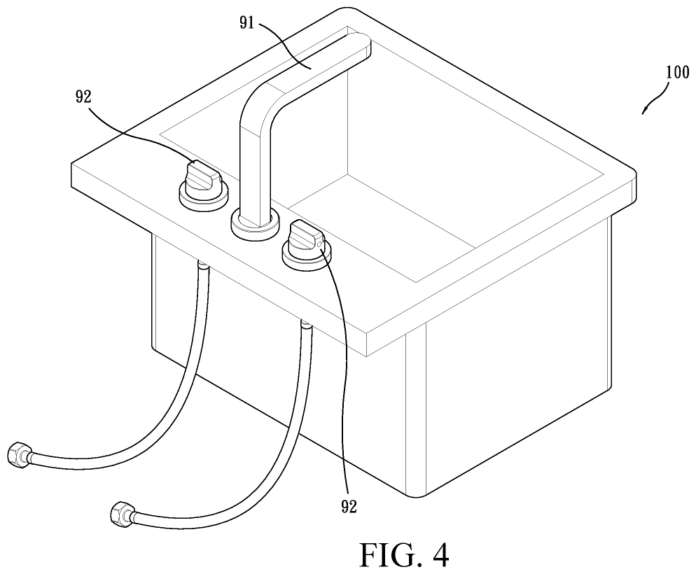

Then, the user only needs to carry out easy mounting of a water dispense port 91, switch knobs 92, and other decorative panels accompanying therewith or additionally purchased (as shown in FIG. 4) to complete the entire operation of installation. In this way, the present invention provides an effect of easy replacement of components (the water dispense port, the switch knobs, and other decorative panels).

Further, since the cold-water valve 21 and the hot-water valve 22 are respectively provided with the cold-water valve stepped face 218 and the hot-water valve stepped face 228, the positions of the cold-water valve top supporting ring 215 and the hot-water valve top supporting ring 225 achieved with downward movements thereof can be limited to thereby make heights of the cold-water valve body 211 and the hot-water valve body 221 projecting beyond the top surface of the surface panel 12 fixed to facilitate the user's operation of mounting the water dispense port 91, the switch knobs 92, and other decorative panels, thereby ensuring consistency for aesthetics.

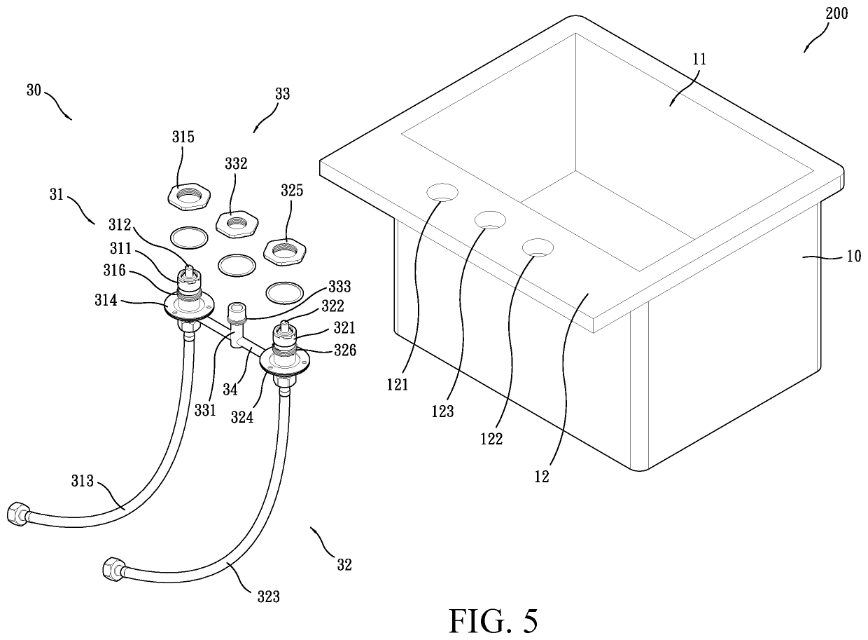

Referring to FIGS. 5-7, a water release apparatus 200 according to a second preferred embodiment of the present invention mainly comprises a container 10 and a valve assembly 30.

Referring to FIG. 5, the container 10 comprises a water outflow basin 11 that is recessed and extended from a top side to a bottom side and a surface panel 12 arranged at one side of a top of the water outflow basin 11. The surface panel 12 comprises a cold-water valve mounting hole 121, a hot-water valve mounting hole 122, and a water release valve mounting hole 123.

Referring to FIGS. 5-7, the valve assembly 30, comprises a cold-water valve 31, a hot-water valve 32, a water release valve 33 and a connection pipe 34. The cold-water valve 31 comprises a cold-water valve body 311, a cold-water valve core 312 arranged in an interior of the cold-water valve body 311, a cold-water pipe 313 connected to a bottom end of the cold-water valve body 311, a cold-water valve bottom supporting member 314, and a cold-water valve top supporting ring 315. The cold-water valve body 311 has an outside circumferential surface that comprises a cold-water valve thread 316. The cold-water valve bottom supporting member 314 integrally projects outwards, in a radial direction, from the outside circumferential surface of the cold-water valve body 311. The cold-water valve top supporting ring 315 is a nut. The hot-water valve 32 comprises a hot-water valve body 321, a hot-water valve core 322 arranged in an interior of the hot-water valve body 321, a hot-water pipe 323 connected to a bottom end of the hot-water valve body 321, a hot-water valve bottom supporting member 324, and a hot-water valve top supporting ring 325. The hot-water valve body 321 has an outside circumferential surface that comprises a hot-water valve thread 326. The hot-water valve bottom supporting member 324 integrally projects outwards, in a radial direction, from the outside circumferential surface of the hot-water valve body 321. The hot-water valve top supporting ring 325 is a nut. The water release valve 33 is arranged between the cold-water valve 31 and the hot-water valve 32, and the water release valve 33 comprises a water release valve body 331 and a water release valve top supporting ring 332. The water release valve body 331 has an outside circumferential surface that comprises a water release valve thread 333. The water release valve top supporting ring 332 is a nut. The connection pipe 34 connects the cold-water valve body 311 of the cold-water valve 31, the hot-water valve body 321 of the hot-water valve 32, and the water release valve body 331 of the water release valve 33.

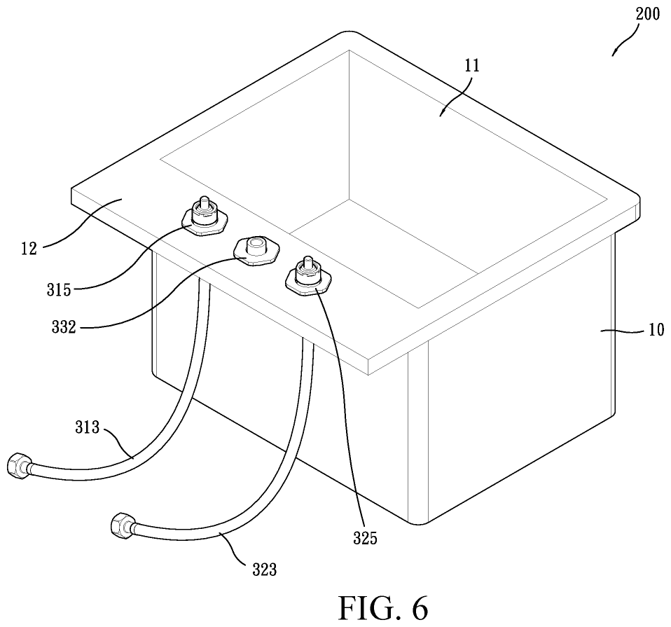

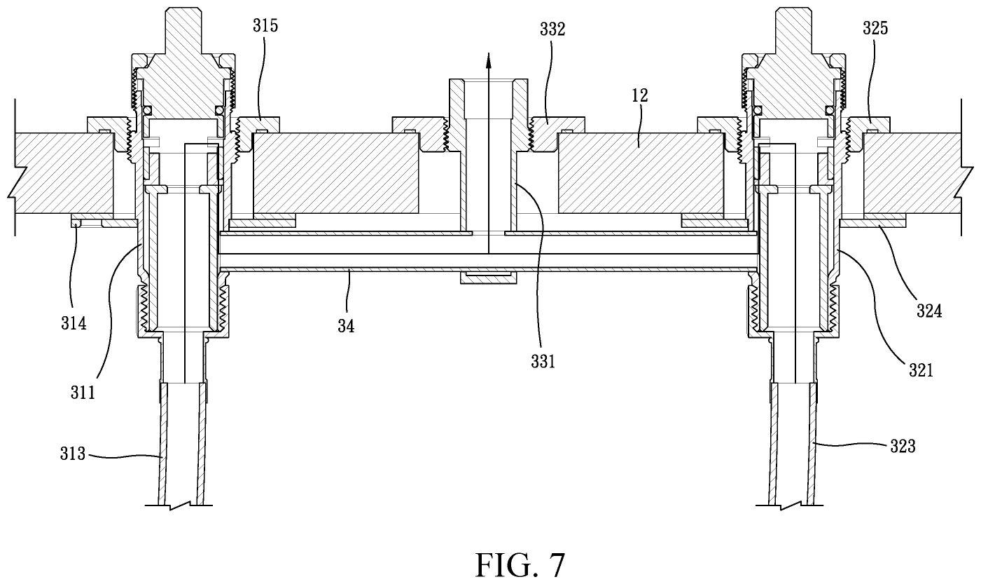

To assemble the instant embodiment, the cold-water valve body 311, the hot-water valve body 321, and the water release valve body 33 are inserted, from the bottom side toward the top side, into the cold-water valve mounting hole 121, the hot-water valve mounting hole 122, and the water release valve mounting hole 123 of the container 10, respectively (as shown in FIGS. 6 and 7), such that the cold-water valve bottom supporting member 314 and the hot-water valve bottom supporting member 324 are positioned against an undersurface of the surface panel 12 of the container 10 (as shown in FIG. 7). And, then, the cold-water valve top supporting ring 315 is screwed to the cold-water valve thread 316, and the hot-water valve top supporting ring 325 is screwed to the hot-water valve thread 326, and the water release valve top supporting ring 332 is screwed to the water release valve thread 333, such that the cold-water valve top supporting ring 315, the hot-water valve top supporting ring 325, and the water release valve top supporting ring 332 are located on and positioned against a top surface of the surface panel 12 of the container 10, while the connection pipe 34 is located on the underside of the surface panel 12 (as shown in FIG. 7).

Thus, the above provides a description of various components of the water release apparatus 200 according to the second embodiment of the present invention and the way of assembling thereof, which, although different from those of the first embodiment, yet achieve the same effect of easy assembling and convenient replacement of components.

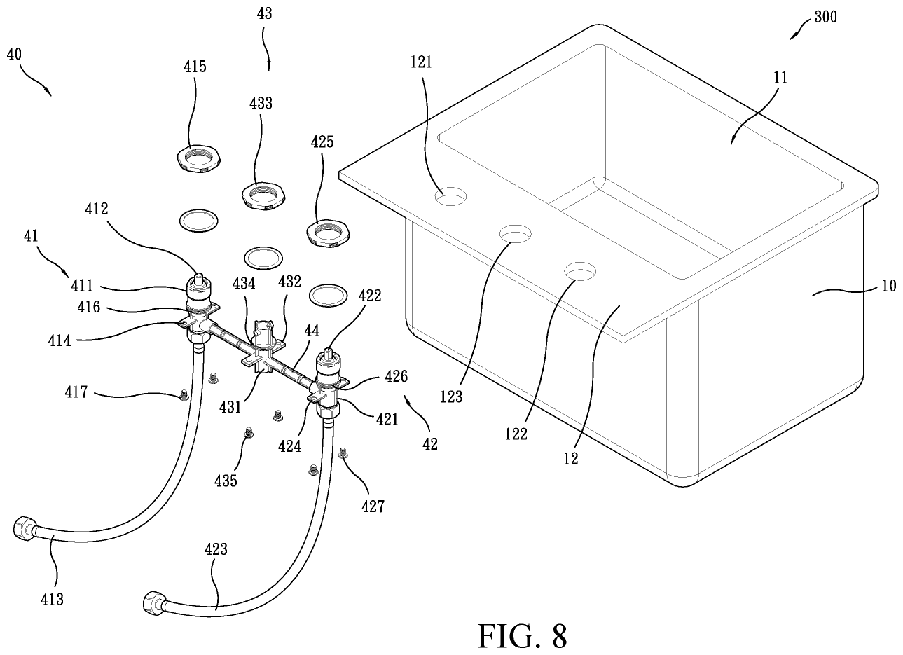

Referring to FIGS. 8-11, a water release apparatus 300 according to a third preferred embodiment of the present invention mainly comprises a container 10 and a valve assembly 40.

Referring to FIG. 8, the container 10 comprises a water outflow basin 11 that is recessed and extended from a top side to a bottom side and a surface panel 12 arranged at one side of a top of the water outflow basin 11. The surface panel 12 comprises a cold-water valve mounting hole 121, a hot-water valve mounting hole 122, and a water release valve mounting hole 123.

Referring to FIGS. 8-11, the valve assembly 40 comprises a cold-water valve 41, a hot-water valve 42, a water release valve 43, and a connection pipe 44. The cold-water valve 41 comprises a cold-water valve body 411, a cold-water valve core 412 arranged in an interior of the cold-water valve body 411, a cold-water pipe 413 connected to a bottom end of the cold-water valve body 411, a cold-water valve bottom supporting member 414, and a cold-water valve top supporting ring 415. The cold-water valve body 411 has an outside circumferential surface that comprises a cold-water valve thread 416. The cold-water valve bottom supporting member 414 integrally projects outwards, in a radial direction, from the outside circumferential surface of the cold-water valve body 411. The cold-water valve top supporting ring 415 is a nut. The hot-water valve 42 comprises a hot-water valve body 421, a hot-water valve core 422 arranged in an interior of the hot-water valve body 421, a hot-water pipe 423 connected to a bottom end of the hot-water valve body 421, a hot-water valve bottom supporting member 424, and a hot-water valve top supporting ring 425. The hot-water valve body 421 has an outside circumferential surface that comprises a hot-water valve thread 426. The hot-water valve bottom supporting member 424 integrally projects outwards, in a radial direction, from the outside circumferential surface of the hot-water valve body 421. The hot-water valve top supporting ring 425 is a nut. The water release valve 43 is arranged between the cold-water valve 41 and the hot-water valve 42, and the water release valve 43 comprises a water release valve body 431, a water release valve bottom supporting member 432, and a water release valve top supporting ring 433. The water release valve body 431 has an outside circumferential surface that comprises a water release valve thread 434. The water release valve bottom supporting member 432 integrally projects outwards, in a radial direction, from the outside circumferential surface of the water release valve body 431. The water release valve top supporting ring 433 is a nut. The connection pipe 44 connects the cold-water valve body 411 of the cold-water valve 41, the hot-water valve body 421 of the hot-water valve 42, and the water release valve body 431 of the water release valve 43.

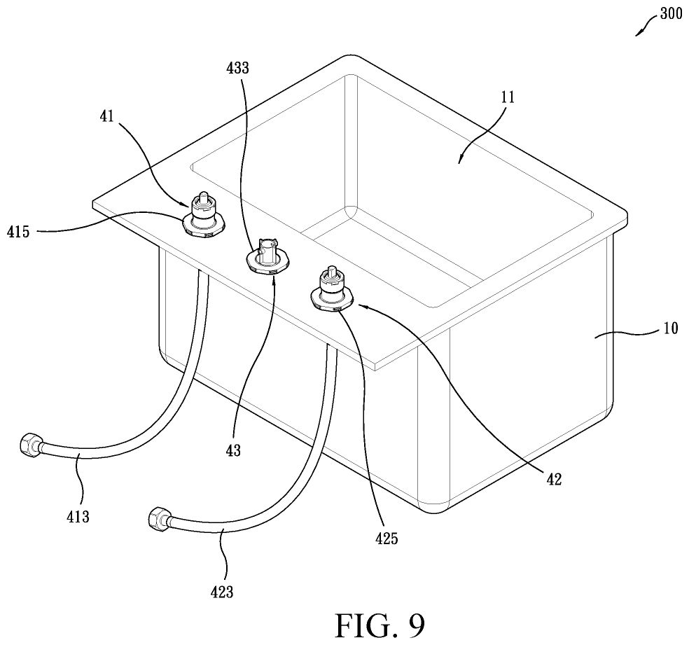

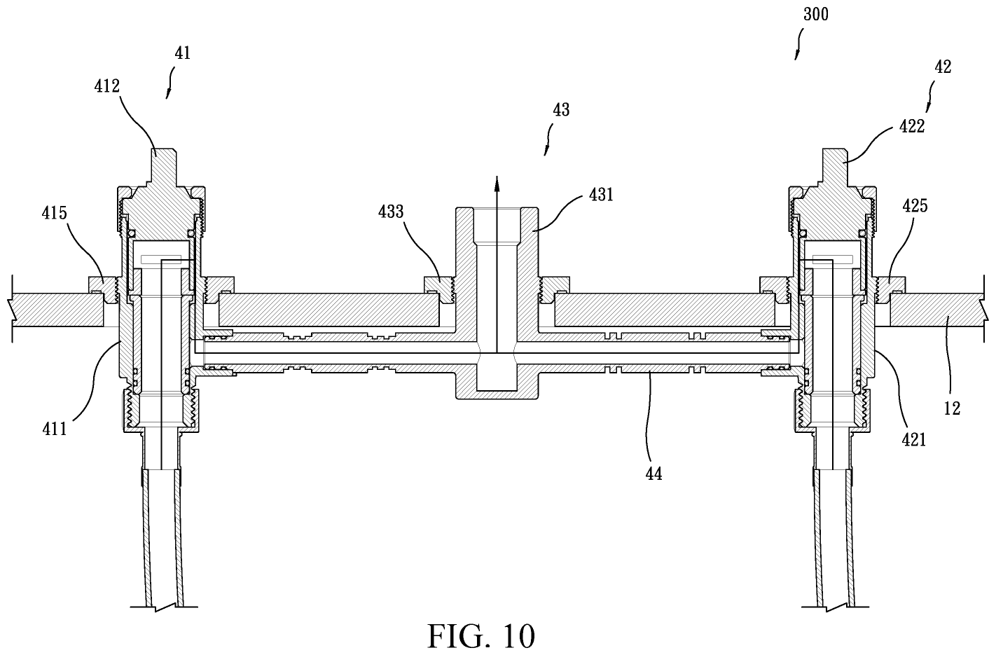

To assemble the instant embodiment, the cold-water valve body 411, the hot-water valve body 421, and the water release valve body 431 are inserted, from the bottom side toward the top side, into the cold-water valve mounting hole 121, the hot-water valve mounting hole 122, and the water release valve mounting hole 123 of the container 10, respectively (as shown in FIGS. 9 and 10), such that the cold-water valve bottom supporting member 414, the hot-water valve bottom supporting member 424, and the water release valve bottom supporting member 432 are positioned against an undersurface of the surface panel 12 of the container 10 (as shown in FIG. 10). And, then, the cold-water valve top supporting ring 415 is screwed to the cold-water valve thread 416, and the hot-water valve top supporting ring 425 is screwed to the hot-water valve thread 426, and the water release valve top supporting ring 433 is screwed to the water release valve thread 434, such that the cold-water valve top supporting ring 415, the hot-water valve top supporting ring 425, and the water release valve top supporting ring 433 are located on and positioned against a top surface of the surface panel 12 of the container 10, while the connection pipe 44 is located on the underside of the surface panel 12 (as shown in FIG. 10).

Thus, the above provides a description of various components of the water release apparatus 300 according to the third embodiment of the present invention and the way of assembling thereof, which, although different from those of the previous embodiments, yet achieve the same effect of easy assembling and convenient replacement of components.

Further, although in the first embodiment and the second embodiment, the cold-water valve bottom supporting member, the hot-water valve bottom supporting member, and the water release valve bottom supporting member are made in the form of a ring, in the instant embodiment the cold-water valve bottom supporting member, the hot-water valve bottom supporting member, and the water release valve bottom supporting member are each made in the form of two tabs integrally project outwards, in a radial direction, from the outside circumferential surface of the cold-water valve body, the hot-water valve body, and the water release valve body. Although the shapes are different, the effect of supporting is the same.

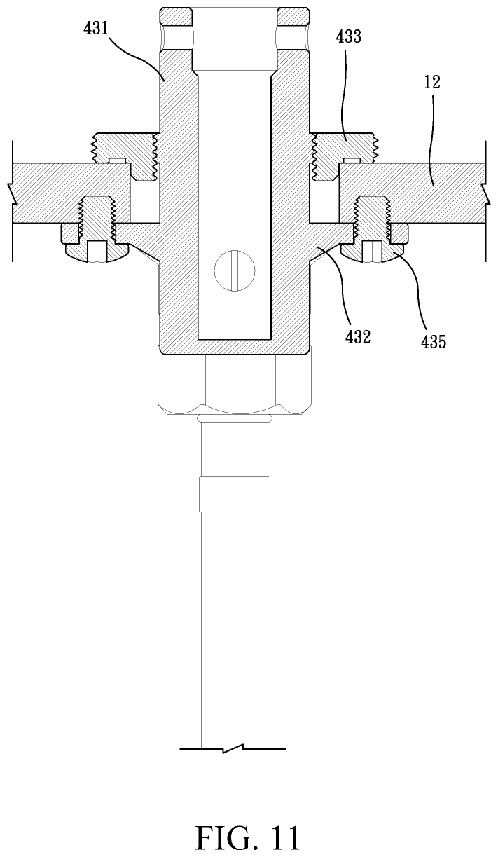

Further, in the instant embodiment, as shown in FIG. 8, the cold-water valve 41 further comprises two cold-water valve screws 417, and the two cold-water valve screws 417 respectively penetrate, from the bottom side to the top side, through the two tabs of the cold-water valve bottom supporting member 414 to then screw to and attach to the undersurface of the surface panel 12. The hot-water valve 42 further comprises two hot-water valve screws 427, and the two hot-water valve screws 427 respectively penetrate, from the bottom side to the top side, through the two tabs of the hot-water valve bottom supporting member 424 to then screw to and attach to the undersurface of the surface panel 12. The water release valve 43 further comprises two water release valve screws 435, and the two water release valve screws 435 respectively penetrate, from the bottom side to the top side, through the two tabs of the water release valve bottom supporting member 432 to then screw to and attach to the undersurface of the surface panel 12 (as shown in FIG. 11). As. such, the strength of combination between the valve assembly 40 and the container 10 is enhanced.

I claim:

1. A water release apparatus, comprising:
a container, which comprises a water outflow basin that is recessed and extended from a top side to a bottom side and a surface panel arranged at one side of the water outflow basin, the surface panel comprising a cold-water valve mounting hole, a hot-water valve mounting hole, and a water release valve mounting hole; and
a valve assembly, which comprises a cold-water valve, a hot-water valve, a water release valve, and a connection pipe, the cold-water valve comprising a cold-water valve body, a cold-water valve bottom supporting member, and a cold-water valve top supporting ring, the cold-water valve body comprising an outside circumferential surface that comprises a cold-water valve lower thread and a cold-water valve upper thread, the cold-water valve bottom supporting member comprising a nut, the cold-water valve top supporting ring comprising a nut, the hot-water valve comprising a hot-water valve body, a hot-water valve bottom supporting member, and a hot-water valve top supporting ring, the hot-water valve body comprising an outside circumferential surface that comprises a hot-water valve lower thread and a hot-water valve upper thread, the hot-water valve bottom supporting member comprising a nut, the hot-water valve top supporting ring comprising a nut, the water release valve being arranged between the cold-water valve and the hot-water valve, the water release valve comprising a water release valve body, a water release valve bottom supporting member, and a water release valve top supporting ring, the water release valve body comprising an outside circumferential surface that comprises a water release valve thread, the water release valve bottom supporting member comprising a nut, the water release valve top supporting ring comprising a nut, the connection pipe connecting the cold-water valve body, the hot-water valve body, and the water release valve body;
wherein the cold-water valve bottom supporting member is screwed to the cold-water valve lower thread, and the hot-water valve bottom supporting member is screwed to the hot-water valve lower thread, and the water release valve bottom supporting member is screwed to the water release valve thread; the cold-water valve body, the hot-water valve body, and the water release valve body are respectively inserted, from the bottom side toward the top side, into the cold-water valve mounting hole, the hot-water valve mounting hole, and the water release valve mounting hole of the container, such that the cold-water valve bottom supporting member, the hot-water valve bottom supporting member, and the water release valve bottom supporting member are positioned against an undersurface of the surface panel; then, the cold-water valve top supporting ring is screwed to the cold-water valve upper thread, and the hot-water valve top supporting ring is screwed to the hot-water valve upper thread, and the water release valve top supporting ring is screwed to the water release valve thread, such that the cold-water valve top supporting ring, the hot-water valve top supporting ring, and the water release valve top supporting ring are located on and positioned against a top surface of the surface panel, while the connection pipe is located on an underside of the surface panel.

2. The water release apparatus according to claim 1, wherein the cold-water valve further comprises a cold-water valve core arranged in an interior of the cold-water valve body and a cold-water pipe connected to a bottom end of the cold-water valve body; the hot-water valve further comprises a hot-water valve core arranged in an interior of the hot-water valve body and a hot-water pipe connected to a bottom end of the hot-water valve body.

3. The water release apparatus according to claim 1, wherein an outside diameter of the cold-water valve upper thread is smaller than an outside diameter of the cold-water valve lower thread, such that a cold-water valve stepped face is formed on the outside surface of the cold-water valve body between the cold-water valve lower thread and the cold-water valve upper thread; an outside diameter of the hot-water valve upper thread is smaller than an outside diameter of the hot-water valve lower thread, such that a hot-water valve stepped face is formed on the outside surface of the hot-water valve body between the hot-water valve lower thread and the hot-water valve upper thread.

4. A water release apparatus, comprising:
a container, which comprises a water outflow basin that is recessed and extended from a top side to a bottom side and a surface panel arranged at one side of the water outflow basin, the surface panel comprising a cold-water valve mounting hole, a hot-water valve mounting hole, and a water release valve mounting hole; and
a valve assembly, which comprises a cold-water valve, a hot-water valve, a water release valve, and a connection pipe, the cold-water valve comprising a cold-water valve body, a cold-water valve bottom supporting member, and a cold-water valve top supporting ring, the cold-water valve body comprising an outside circumferential surface that comprises a cold-water valve thread, the cold-water valve bottom supporting member integrally projecting outwards, in a radial direction, from the outside circumferential surface of the cold-water valve body, the cold-water valve top supporting ring comprising a nut, the hot-water valve comprising a hot-water valve body, a hot-water valve bottom supporting member, and a hot-water valve top supporting ring, the hot-water valve body comprising an outside circumferential surface that comprises a hot-water valve thread, the hot-water valve bottom supporting member integrally projecting outwards, in a radial direction, from the outside circumferential surface of the hot-water valve body, the hot-water valve top supporting ring comprising a nut, the water release valve being arranged between the cold-water valve and the hot-water valve, the water release valve comprising a water release valve body and a water release valve top supporting ring, the water release valve body comprising an outside circumferential surface that comprises a water release valve thread, the water release valve top supporting ring comprising a nut, the connection pipe connecting the cold-water valve body, the hot-water valve body, and the water release valve body;
wherein the cold-water valve body, the hot-water valve body, and the water release valve body are respectively inserted, from the bottom side toward the top side, into the cold-water valve mounting hole, the hot-water valve mounting hole, and the water release valve mounting hole of the container, such that the cold-water valve bottom supporting member and the hot-water valve bottom supporting member are positioned against an undersurface of the surface panel; then, the cold-water valve top supporting ring is screwed to the cold-water valve thread, and the hot-water valve top supporting ring is screwed to the hot-water valve thread, and the water release valve top supporting ring is screwed to the water release valve thread, such that the cold-water valve top supporting ring, the hot-water valve top supporting ring, and the water release valve top supporting ring are located on and positioned against a top surface of the surface panel, while the connection pipe is located on an underside of the surface panel.

5. The water release apparatus according to claim 4, wherein the cold-water valve further comprises a cold-water valve core arranged in an interior of the cold-water valve body and a cold-water pipe connected to a bottom end of the cold-water valve body; the hot-water valve further comprises a hot-water valve core arranged in an interior of the hot-water valve body and a hot-water pipe connected to a bottom end of the hot-water valve body.

6. The water release apparatus according to claim 4, wherein the cold-water valve bottom supporting member and the hot-water valve bottom supporting member are each in the form of a ring.

7. The water release apparatus according to claim 4, wherein the cold-water valve bottom supporting member and the hot-water valve bottom supporting member are each in the form of two tabs.

8. The water release apparatus according to claim 4, wherein the water release valve further comprises a water release valve bottom supporting member, and the water release valve bottom supporting member integrally projects outwards, in a radial direction, from the outside circumferential surface of the water release valve body.

9. The water release apparatus according to claim 8, wherein the water release valve bottom supporting member comprises two tabs.

10. The water release apparatus according to claim 8, wherein the cold-water valve further comprises at least one cold-water valve screw, the cold-water valve screw penetrating, from the bottom side to the top side, through the cold-water valve bottom supporting member to screw to and attach to the surface panel; the hot-water valve further comprises at least one hot-water valve screw, the hot-water valve screw penetrating, from the bottom side to the top side, through the hot-water valve bottom supporting member to screw to and attach to the surface panel; the water release valve further comprises at least one water release valve screw, the water release valve screw penetrating, from the bottom side to the top side, through the water release valve bottom supporting member to screw to and attach to the surface panel.
